(19) United States
(12) Patent Application Publication
(10) Pub. No.: US 2006/0219420 A1
(43) Pub. Date: Oct. 5, 2006

(54) Apparatus for adjusting torque output of power tool

(76) Inventor: Yu-Ming Lin, Nantiu County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/098,530

(22) Filed: Apr. 5, 2005

(51) Int. Cl. B23Q 5/00

(52) U.S. Cl. 173/176

(57) ABSTRACT

An adjusting apparatus has a barrel with a closed end, a neck portion on the closed end and bores on the closed end. An adjusting assembly with an outer tube and an inner tube is connected to the neck portion of the barrel. A driving member, which is received in the barrel, has posts inserted into the bores of the barrel respectively and extruded out of the barrel to be rested on the adjusting assembly. A washer assembly has a bearing is received in the barrel behind the driving member. A movable member has a gear portion and two blocks to be received in the barrel. A transmission shaft has an annular gear portion to be inserted into the barrel via the neck portion and the gear portion of the transmission shaft is meshed with the gear portion of the movable member. A spring is received in the barrel behind the washer assembly to urge the driving member outwards.

### BACKGROUND OF THE INVENTION

1. Field of the Invention

The present invention relates generally to a hand-held power tool, and more particularly to an apparatus for adjusting the torque output of a power tool.

2. Description of the Related Art

A conventional hand-held power tool with the impact function is shown in FIG. 1 and FIG. 2, which mainly includes a tube 10 and a transmission shaft 11 in the tube 10. The transmission shaft 11 has two blocks 12 on an end thereof, washers 13 fitted thereto, a hub 14 received in the tube 10 and a clip member 15 connected to the transmission shaft 11. The tube 10 has a transmission base 16 at the rear end thereof, in which an axle 17 is provided. The axle 17 is connected to the blocks 12 of the transmission shaft 11 so as to drive the transmission shaft 11 for rotation by a motor (not shown). The transmission base 16 further has two gear portions 18 and a spring 19. While the transmission shaft 11 is rotated, the blocks 12 of the transmission shaft 11 is moved relative to the gear portions 18 so that the transmission base 16 is reciprocated to have a percussion motion.

Because there is a fixed overlapped section of the blocks 12 and the gear portions 18, the motor has to provide a sufficient power to the transmission shaft 11 to make the blocks 12 over the gear portions 18. It causes damage to the blocks 12 and the gear portions 18. Furthermore, the conventional power tools always have the maximum torque at start, even when we only need a smaller torque.

### SUMMARY OF THE INVENTION

The primary objective of the present invention is to provide an apparatus of adjusting torque of a power tool, which is capable of adjusting the output power as the user requires.

According to the objective of the present invention, an adjusting apparatus, which is installed to a transmission base with an axle therein and at least a gear block on an end thereof of a power tool, comprises a barrel having a closed end, a neck portion on the closed end, a through hole communicated with the neck portion and a plurality of bores on the closed end. An adjusting assembly with an outer tube and an inner tube is connected to the neck portion of the barrel. The inner tube is moved relative to the outer tube. A driving member, which is received in the barrel, has a plurality of posts inserted into the bores of the barrel respectively and extruded out of the barrel to be rested on the adjusting assembly. A washer assembly has a bearing and is received in the barrel behind the driving member. A movable member has an annular gear portion on an interior side adjacent to an end thereof and two blocks on an exterior side adjacent to an end opposite to the end with the gear portion. The end with the gear portion of the movable member is inserted into the bearing of the washer assembly. A transmission shaft has a clipping hole at an end thereof and an annular gear portion on an exterior side adjacent to an end opposite to the end with the clipping hole. The end with the gear portion of the transmission shaft is inserted into the barrel via the neck portion and the gear portion of the transmission shaft is meshed with the gear portion of the movable member, and the axle of the transmission is connected to an end of the gear portion, and a spring is received in the barrel behind the washer assembly to urge the driving member and the washer assembly attached on a front end of the barrel.

### BRIEF DESCRIPTION OF THE DRAWINGS

FIG. 1 is an exploded view of the conventional power tool;

FIG. 2 is a sectional view of the conventional power tool;

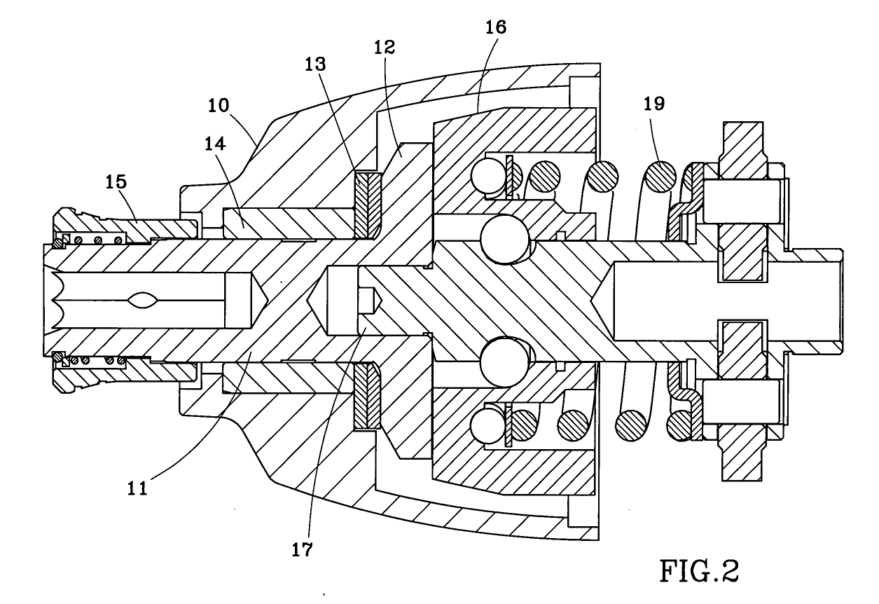

FIG. 3 is an exploded view of a preferred embodiment of the present invention;

FIG. 4 is a sketch diagram of the preferred embodiment of the present invention, showing the movable member moved to the front position;

FIG. 5 is a sketch diagram of the preferred embodiment of the present invention, showing the movable member moved to the rear position, and

FIG. 6 is a sectional view of the movable member at the front position of the preferred embodiment of the present invention.

FIG. 7 is a sectional view of the movable member at the rear position of the preferred embodiment of the present invention.

### DETAILED DESCRIPTION OF THE INVENTION

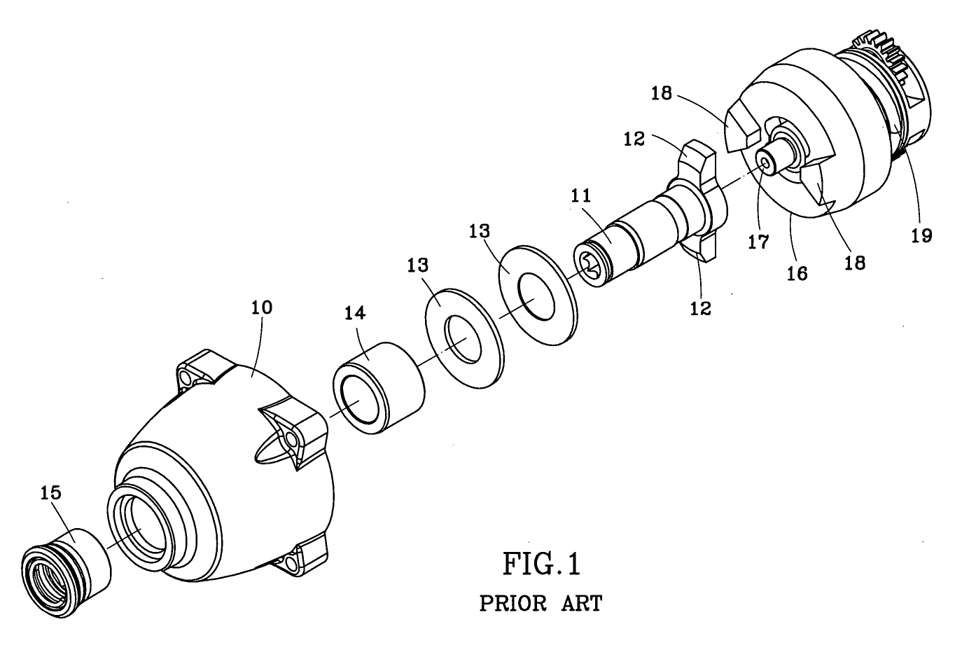

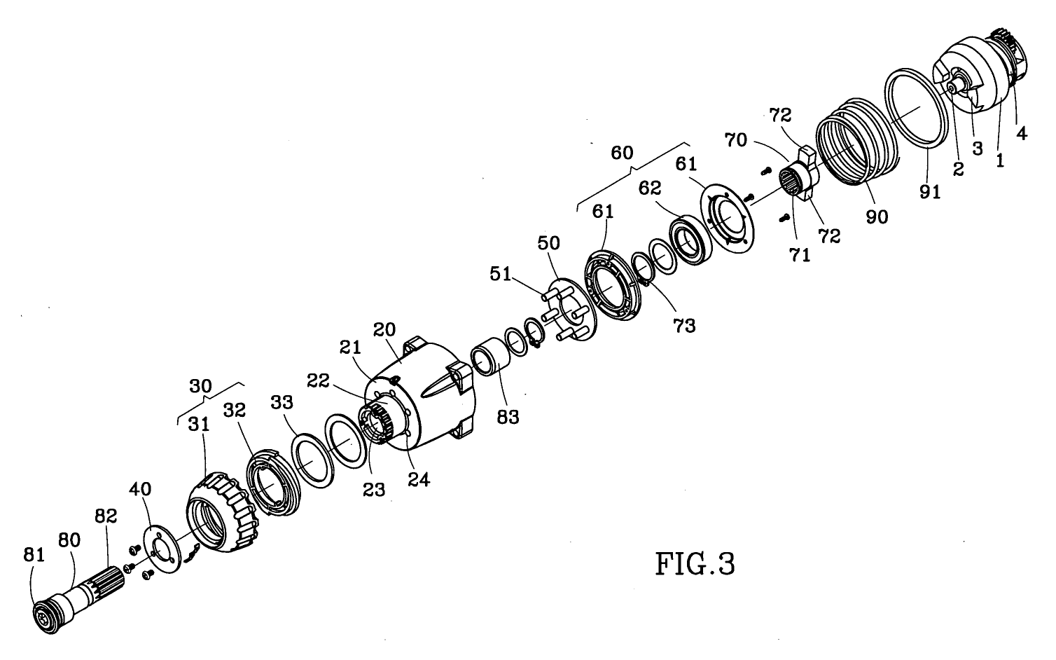

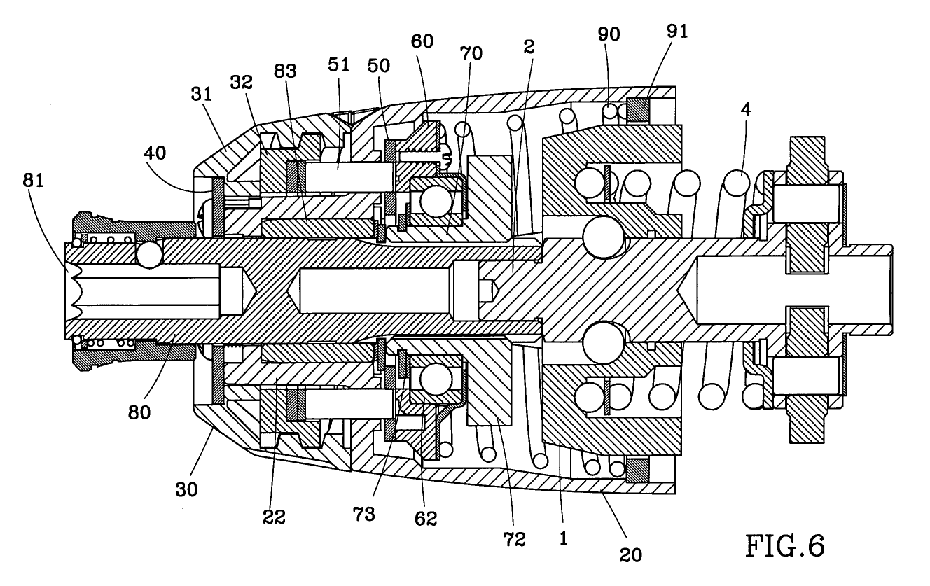

As shown in FIG. 1, an adjusting apparatus of the preferred embodiment of the present invention is installed at a front of a power tool. The power tool has a transmission base 1 with an axle 2 therein, two gear blocks 3 at a front end and a spring 4 at a rear end. The axle 2 is connected to a motor, as shown in FIG. 3 and FIG. 6.

The adjusting apparatus of the present invention comprises a barrel 20 with a closed end 21, a neck portion 22 on the closed end 21, a through hole 23 to the neck portion 22 and a plurality of bores 24 on the closed end 21 around the neck portion 22. The neck portion 22 has a diameter smaller than that of the barrel 20.

An adjusting assembly 30, which is mated with the neck portion 22 of the barrel 20, has an outer tube 31, an inner tube 32 and an annular plate 33 between the inner tube 32 and the closed end 21 of the barrel 20. The outer tube 31 has a threaded section at an interior side and the inner tube 32 has a threaded section at an exterior side.

A lid plate 40 is connected to a distal end of the neck portion 22 of the barrel 20 to restrict the adjusting assembly 30 between the closed end 21 of the barrel 20 and the lid plate 40.

A driving member 50, which is an annular element, is received in the barrel 20. The driving member 50 has a plurality of posts 51 to be inserted into the bores 24 on the closed end 21 of the barrel 20 respectively and against the annular plate 33.

A washer assembly 60 has two washers 61 and a bearing 62 between the washers 61. The washer assembly 60 is received in the barrel 20 behind the driving member 50.

A movable member 70 has a tube portion with an annular gear portion 71 at an interior side adjacent to an end thereof and two blocks 72 at an exterior side adjacent to an end thereof opposite to the gear portion 71. The end with the gear portion 71 of the movable member 70 is inserted into the bearing 62 of the washer assembly 60 and locked by a C ring 73 so that the movable member 70 is moved along with the washer assembly 60.

A transmission shaft 80, which is an elongated tube, has a clipping hole 81 at an end thereof and an annular gear portion 82 at an exterior side adjacent to an end opposite to the clipping hole 81. The end with the gear portion 82 of the transmission shaft 80 is inserted into the barrel 20 via the neck portion 22 and through the adjusting assembly 30, the driving member 50 and the washer assembly, and finally, the end of the transmission is mated with the axle 2 of the transmission base 1. A bearing 83 is fitted to the transmission shaft 80.

A spring 90 is received in the barrel 20 behind the driving member 50 and the washer assembly 60. The spring 90 has opposite ends against the washer assembly 60 and an annular member 91 fixed in the barrel 20 so that the driving member 50 and the washer assembly 60 are exerted by the spring 90 to keep the posts 51 of the driving member 50 at their upper positions.

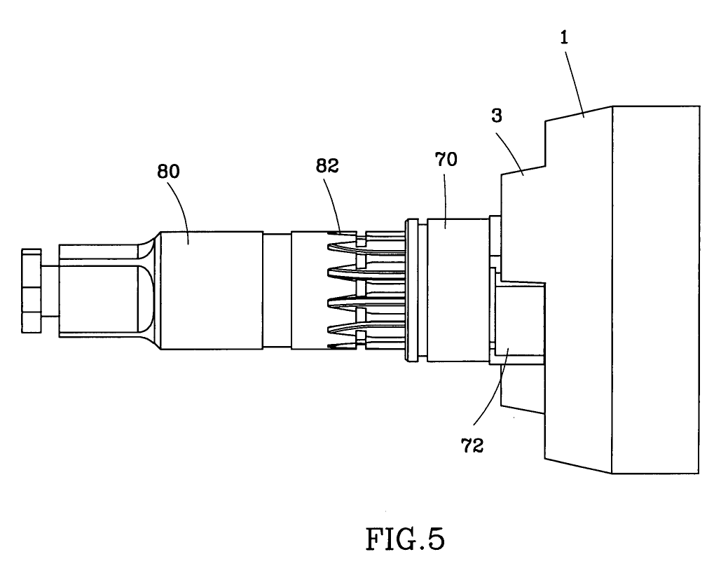

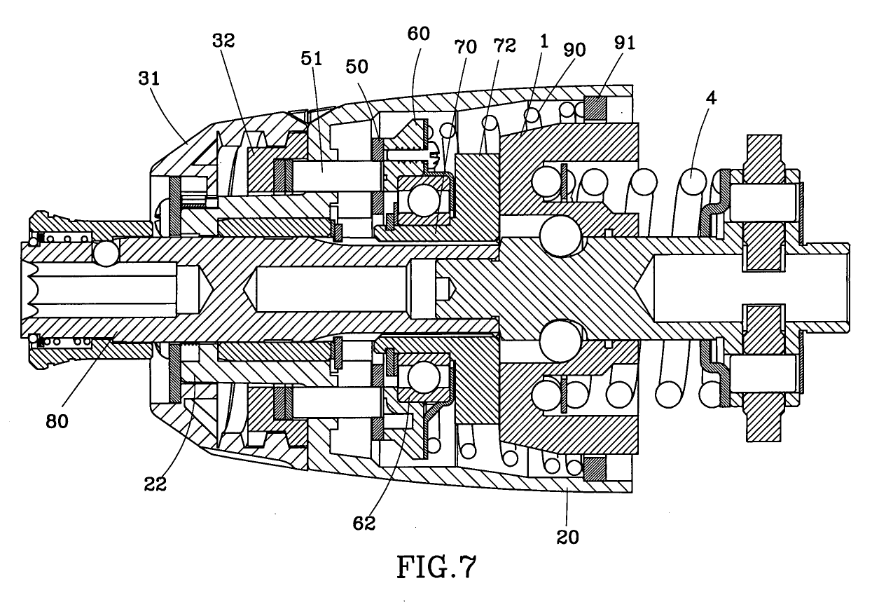

The transmission shaft 80 of the adjusting apparatus of the present invention is driven by a motor of the hand-held power tool via the axle 2. The main character of the present invention is that a distance between the movable member 70 and the gear blocks 3 is adjustable by manipulation to change the torque output. The steps of adjusting include rotating the outer tube 31 of the adjusting assembly 30 to move the inner tube 32 inwards or outwards via the meshed threaded sections. While the inner tube 32 is moved inwards, the inner tube 32 drives the annular plate 33 to push the posts 51 of the driving member 50 toward the transmission base 1 and compress the spring 90, as shown in FIG. 5 and FIG. 7. As a result, the distance between the movable member 70 and the gear blocks 3 is shorter so that the motor has to provide a greater power (or torque) to rotate the movable member 70 over the gear blocks 3.

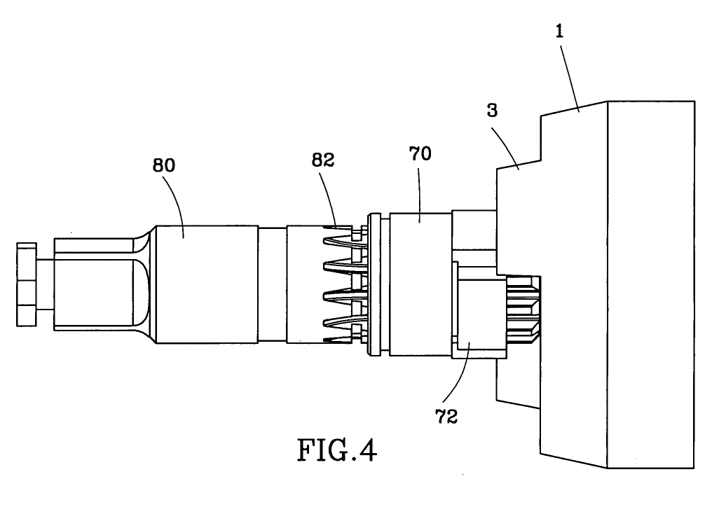

On the contrary, while the inner tube 32 is moved outwards, the driving member 50, the washer assembly 60 and the movable member 70 are moved away from the transmission base I by the spring 90, as shown in FIG. 6 and FIG. 4. The distance between the movable member 70 and the gear blocks 3 is greater so that the motor provides a smaller power (or torque) that could start the movable member 70.

As a result, user can adjust the output of the torque, as he/she requires.

What is claimed is:

1. An adjusting apparatus, which is installed to a transmission base with an axle therein and at least a gear block on an end thereof of a power tool, comprising:
a barrel having a closed end, a neck portion on the closed end, a through hole communicated with the neck portion and a plurality of bores on the closed end;
an adjusting assembly connected to the neck portion of the barrel having an outer tube and an inner tube, wherein the inner tube is moved relative to the outer tube;
a driving member received in the barrel having a plurality of posts inserted into the bores of the barrel respectively and extruded out of the barrel to be rested on the adjusting assembly;
a washer assembly having a bearing received in the barrel behind the driving member;
a movable member having an annular gear portion on an interior side adjacent to an end thereof and two blocks on an exterior side adjacent to an end opposite to the end with the gear portion, wherein the end with the gear portion of the movable member is inserted into the bearing of the washer assembly;
a transmission shaft having a clipping hole at an end thereof and an annular gear portion on an exterior side adjacent to an end opposite to the end with the clipping hole, wherein the end with the gear portion of the transmission shaft is inserted into the barrel via the neck portion and the gear portion of the transmission shaft is meshed with the gear portion of the movable member, and the axle of the transmission is connected to an end of the gear portion, and
a spring received in the barrel behind the washer assembly to urge the driving member and the washer assembly attached on a front end of the barrel.

2. The adjusting apparatus as defined in claim 1, wherein the outer tube and the inner tube of the adjusting assembly have a threaded section respective to be meshed with each other.

3. The adjusting apparatus as defined in claim 1, further comprising a lid plate connected to a distal end of the neck portion of the barrel to restrict the adjusting assembly between the closed end of the barrel and the lid plate.

4. The adjusting apparatus as defined in claim 1, further comprising a bearing fitted to the transmission shaft.

5. The adjusting apparatus as defined in claim 1, further comprising a C ring clipped on the movable member to secure the washer assembly so that the washer assembly is moved along with the movable member

6. The adjusting apparatus as defined in claim 1, wherein the spring has opposite ends urging the washer assembly and an annular member in the barrel to attach the driving member and the washer assembly on the front end of the barrel.
